(19) United States
(12) Patent Application Publication
(10) Pub. No.: US 2006/0260139 A1
(43) Pub. Date: Nov. 23, 2006

(54) Squeeze fork

(76) Inventor: Thomas H. Wolf, Bensenville, IL (US)

Correspondence Address: BARNES & THORNBURG LLP, P.O. BOX 2786, CHICAGO, IL, 60690-2786, US

(21) Appl. No.: 11/133,757

(22) Filed: May 20, 2005

(51) Int. Cl. A47J 43/28

(52) U.S. Cl. 30/323

(57) ABSTRACT

A fork assembly has a handle. The handle includes a first and second handle member. Each of the first and second handle members has a grip. The first and second handle members are joined together at their rear portione by a resilient member. The resilient member biases the first and second handle member so that they remain spaced apart until squeezed together by a user. The fork further has an ejector coupled to the handle. The ejector compresses and secures the first and second handle members within the predetermined distance when the fork is in a resting state. An abutment on the inside of the handle prevents over squeezing of the fork assembly

### FIELD OF INVENTION

The present application concerns a fork assembly.

### BACKGROUND

Squeeze forks are known in the art. Patent DES 402860, entitled “Fork”, inventor James L. Stills discloses an ornamental design for a squeeze fork. Patent DES 421880, inventor Stills discloses a further ornamental design for a squeeze fork. Patent DES 485475, inventor Tom Wolf, discloses a further ornamental design for a squeeze fork.

U.S. Pat. No. 1,065,433, inventor James Cavanaugh, discloses a vegetable fork. The vegetable fork has as its object providing an ejector for the fork. The ejector and fork are so designed that it is unnecessary for the ejector portion of the fork to travel to the extreme ends of the tines to provide for positive ejection of any material which may be located upon the tines. The device has a fork handle coupled with a spring arm. The spring arm is pivotally connected to an ejecting arm. The ejecting arm has an enlarged portion and a curved portion which forms an extended knob or lug which is adapted to come in contact with material which may be upon the fork tines. The ejecting arm is so formed with the enlarged portion and the extended knob or lug so that it is possible to position the ejecting arm so that the apertures in the enlarged portion will not have to travel to the extreme ends of the fork prongs or tines but that the curved projection will extend beyond the ends of the tines and will thereby successfully eject the speared material.

### SUMMARY

A fork assembly embodying the present invention includes a handle with first and second handle members. The first and second handle members each have outward facing surfaces. A raised abutment is between said outward surfaces. A resilient member joins the first and second handle members. An ejector is coupled to the second handle member and to tines extending from the first handle member.

The fork assembly has a resting state wherein the handle members are biased a first distance apart by a force of separation exerted by said resilient member. The force is counteracted by a force exerted by said ejector.

The fork assembly has a compressed state wherein the handle members are compressed together so that they are a second distance apart. The abutment abuts up against another portion of said fork. The other portion is also between the outer surfaces of the handle members. The other portion may form part of the abutment. In this case the abutment would have opposite first and second abutment members.

### BRIEF DESCRIPTION OF THE DRAWINGS

FIG. 1 discloses an elevated top perspective view of a squeeze fork which embodies the present invention;

FIG. 2 is a lower, bottom perspective view of the squeeze fork;

FIG. 3 is a front view of the squeeze fork;

FIG. 4 is a rear view of the squeeze fork;

FIG. 5 is a top view of the squeeze fork;

FIG. 6 is a right sided view of the squeeze fork showing the squeeze fork in a resting state;

FIG. 7 is a bottom view of the squeeze fork;

FIG. 8 is a right sided view of the squeeze fork showing the squeeze fork in a fully squeezed optimal ejecting position.

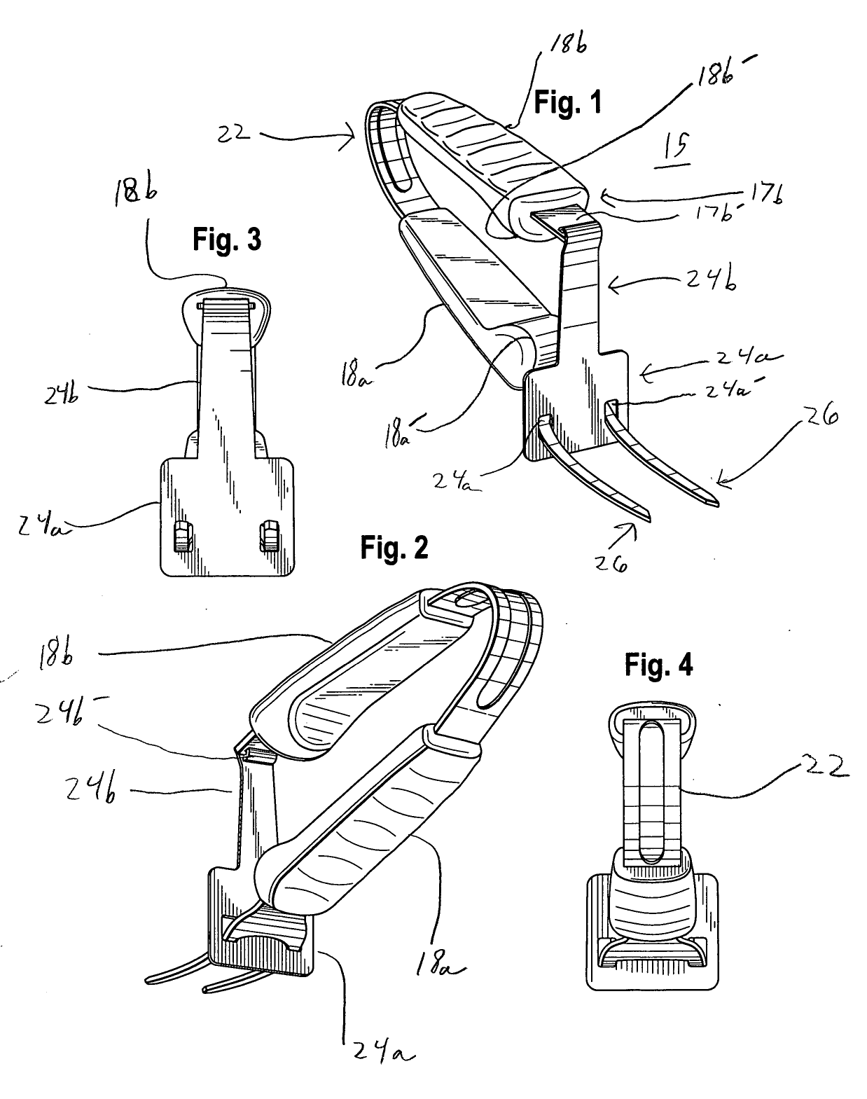

### DETAILED DESCRIPTION

In one embodiment of the present invention, a fork 15 has a handle 17a, 17b. The handle comprises a first 17a and second 17b member. Each first and second member has outward surfaces, 17a′, 17b′. Each of the first and second members has a grip 18a, 18b thereon. The first 17a and second 17b members are spaced apart a distance 19 when the fork is in the resting state. The first 17a and second 17b members form first 17a and second 17b handle members.

The first and second members are joined together at their rear portion by a resilient member 22. The resilient member 22 is u-shaped and is integral with the first and second handle members. The u-shaped member 22 forms a rear member of the handle. The u-shaped member 22 biases the first 17a and second 17b handle members so that they remain spaced apart distance 19 until squeezed together by a user.

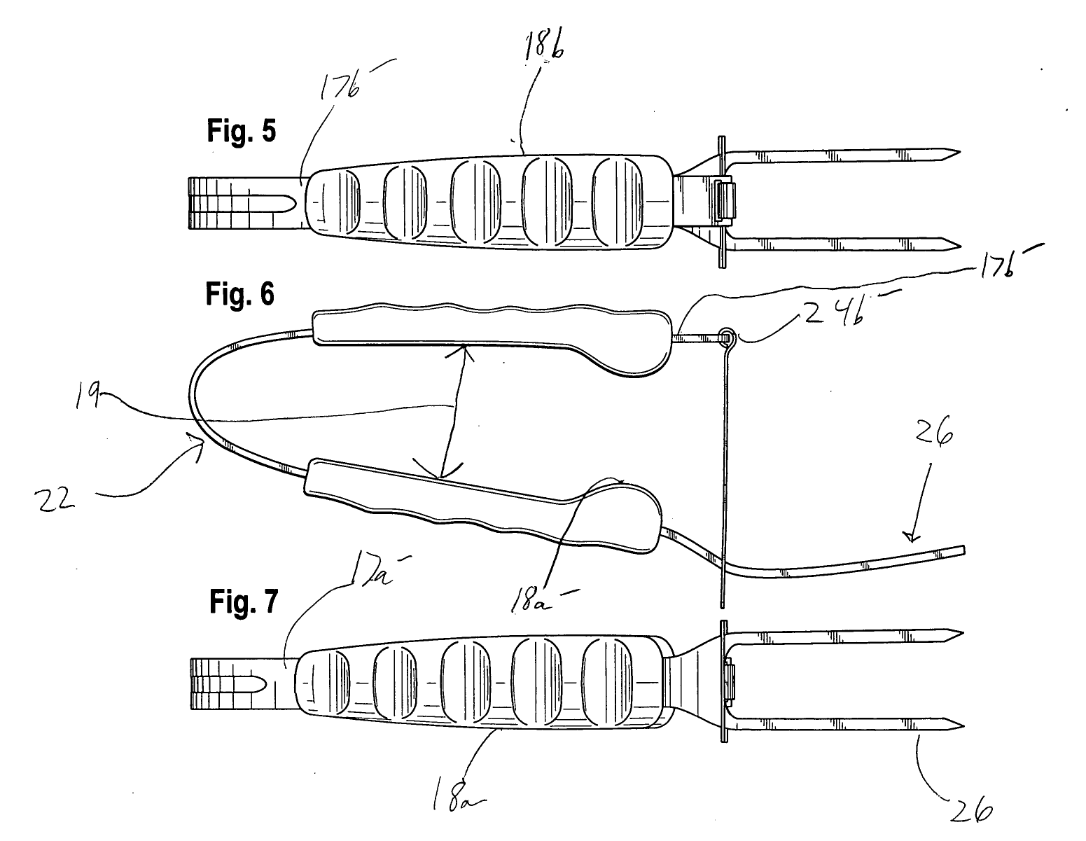

The fork further has an ejector 24a, 24b with a first portion 24a and a second portion 24b. The second portion 24b forms an elongated arm. The arm at one end 24b′ is pivotally coupled to the second handle member. The ejector first portion 24a forms a material pushing member which is slidably engaged to tines or prongs 26. The prongs 26 are engaged to the first portion 24a by way of passing through apertures 24a′ in the first portion 24a. The ejector 24a, 24b compresses and secures the first 17a and second 17b handle members (see FIG. 6) within the predetermined spacing 19 when the fork is in the resting state.

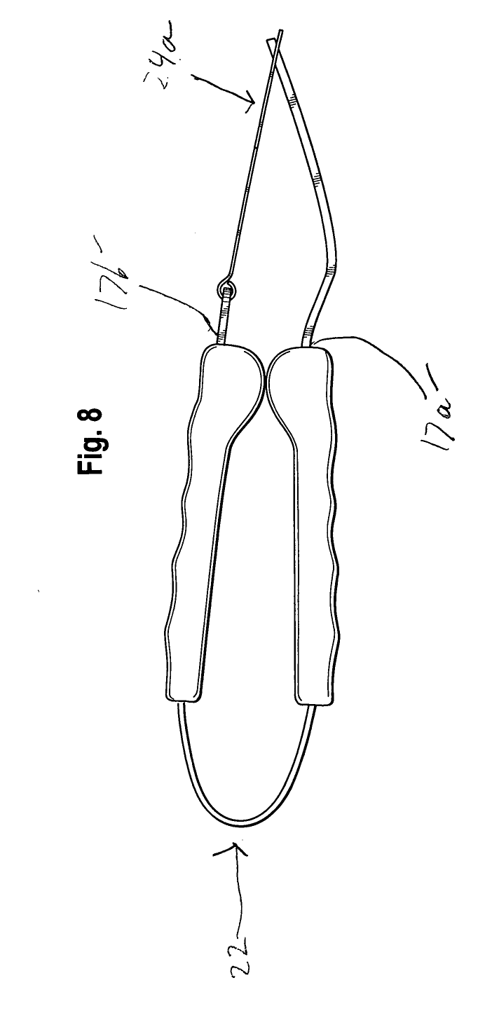

The handle 17a, 17b has, between its outward surfaces 17a′, 17b′, raised members 18a′, 18b′. The raised members 18a′, 18b′ are oppositely oriented on the grips 18a, 18b so that they abut each other when the fork is in a fully squeezed state, see FIG. 8.

As can be seen in FIG. 8, the fork 15 is configured so that when it is in the squeezed state, the apertures 24a′, in the first portion 24a, travel towards the forefront of the tines 26 but do not travel to the extreme ends thereof. The abutments, 18a′, 18b′, when the handle members 17a, 17b are squeezed towards each other, come into contact with each other. The abutments prevent further squeezing of the fork 15. The prevention of further squeezing stops the ejector 24a, 24b from further sliding along the prongs 26 thereby preventing the ejector 24a, 24b from becoming disengaged from the prongs 26.

The abutments 18a′, 18b′ allow for an automatic stop of the ejector first portion 24a at an optimal position, FIG. 8, without requiring a user to squeeze the first and second handle member 17a, 17b in such close proximity to each other. The abutments also allow a user to achieve the optimal ejection position, FIG. 8, without worrying about over-squeezing the fork so as to disengage the ejector 24a, 24b from the prongs 26.

While the invention has been described with a high degree of particularity, it will be appreciated by those skilled in the art that modifications may be made thereto. Therefore it is to be understood that the present invention is not limited to the embodiment described above, but encompasses any and all embodiments within the scope of the following claims.

I claim:

1. A fork assembly comprising:
a handle with a first handle and a second handle member;
an ejector coupled to a portion of said fork;
a raised abutment between outward surfaces of said first and second handle members;
a resilient member joining said first and second handle members, a resting state, wherein said handle members are separated a first distance apart by a force of separation exerted by said resilient member and said handle members are retained from separating beyond said distance by a portion of said fork; and
a compressed state wherein said handle members are compressed together so that they are a second distance apart, said second distance less than said first distance; and wherein
said abutment, when said fork is in said compressed state, abuts up against a portion of said fork, said portion also between said outward surfaces of said first and second handle members.

2. The fork assembly of claim 1 further comprising a first grip on said first handle member; and wherein
said abutment includes a first raised portion on said first grip.

3. The fork assembly of claim 2 further comprising:
a second grip on said second handle member; and wherein said portion of said fork includes a second raised portion on said second grip.

4. The fork assembly of claim 3, wherein, when in said compressed state, said first and second raised portions are in contact with each other.

5. The fork assembly of claim 1 further comprising:
a plurality of prongs or tines coupled to said ejector; and wherein
in said compressed state, a portion of said ejector extends beyond said prongs or tines.
